(19) United States
(12) Patent Application Publication
(10) Pub. No.: US 2026/0170405 A1
(43) Pub. Date: Jun. 18, 2026

(54) MULTIMODAL MACHINE-LEARNING MODEL FOR PREDICTING ITEM USAGE

(71) Applicant: Maplebear Inc., San Francisco, CA (US)

(72) Inventors: Brent Scheibelhut, Toronto (CA); Charles Wesley, San Diego, CA (US); Naval Shah, Toronto (CA); Mark Oberemk, Toronto (CA)

(21) Appl. No.: 18/986,538

(22) Filed: Dec. 18, 2024

(51) Int. Cl. G06N 20/00

(52) U.S. Cl. CPC G06N 20/00

(57) ABSTRACT

An online system trains a multimodal machine-learning model to predict a rate of using an item that can be ordered at the online system by a user. The machine-learning model is trained by using a plurality of training examples, where each training example includes training images associated with a respective training user that are related to a respective item from the collection of items, and data related to conversion of the respective item by the respective training user. Upon receiving images of user's physical spaces that store items, the online system applies the trained machine-learning model to the images to output a rate of using a specific item by the user. Based on the predicted rate, the online system generates a user interface signal causing a device associated with the user to display a user interface with a user interface element for use by the user to restock the item.

### BACKGROUND

An online system is used for placing online orders so that users of the online system can perform online purchases of various items (e.g., groceries) offered by sources (e.g., retailers). It is desirable that the online system makes recommendations to users in a way that is informed of their consumption rates for various items. But there is no good way to determine a user's consumption of a particular product. For example, purchase history may be incomplete because the online system has the knowledge only of what users buy on the online system platform. And users are unlikely to self-report items not purchased on the online system platform.

Therefore, there is a technical problem of how to determine a user's consumption of a specific item automatically, without relying on a user to report this information.

### SUMMARY

Embodiments of the present disclosure are directed to training and using a multimodal machine-learning model to predict a rate of using (e.g., consuming) a given item that can be ordered at an online system by a specific user of the online system, i.e., to predict a usage rate for a specific user-item pair.

In accordance with one or more aspects of the disclosure, the online system receives, via a network and from one or more devices associated with a user of the online system, one or more images of one or more physical spaces of the user that store a plurality of items. The online system accesses a usage prediction machine-learning model of the online system, wherein the usage prediction machine-learning model is trained by receiving, via the network from a set of devices associated with a training set of users of the online system, a training set of images of a set of physical spaces of the training set of users that store a collection of items, retrieving, from a database of the online system, conversion data including information about conversion of the collection of items by the training set of users, generating a plurality of training examples using the training set of images and the conversion data, each of the plurality of training examples including one or more training images from the training set of images associated with a respective training user from the training set of users that are related to a respective item from the collection of items, and a portion of the conversion data related to conversion of the respective item by the respective training user, for each of the plurality of training examples, applying the usage prediction machine-learning model to output a respective rate of a plurality of rates of using the respective item by the respective training user, and updating, for each of the plurality of training examples and based on the plurality of rates, a set of parameters of the usage prediction machine-learning model. The online system applies the usage prediction machine-learning model to the one or more images to output a rate of using an item of the plurality of items by the user. The online system generates, based at least in part on the rate of using the item by the user, a first user interface signal. The online system sends, via the network, the first user interface signal to a device of the one or more devices associated with the user, wherein the sending the first user interface signal causes the device to display a user interface with a user interface element, and wherein selection of the user interface element triggers an order of the item.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example architectural flow diagram of training and applying a machine-learning model to predict a rate of using an item by a user of an online system, in accordance with one or more embodiments.

FIG. 4 is a flowchart for a method of training and applying a machine-learning model to predict a rate of using an item by a user of an online system, in accordance with one or more embodiments.

### DETAILED DESCRIPTION

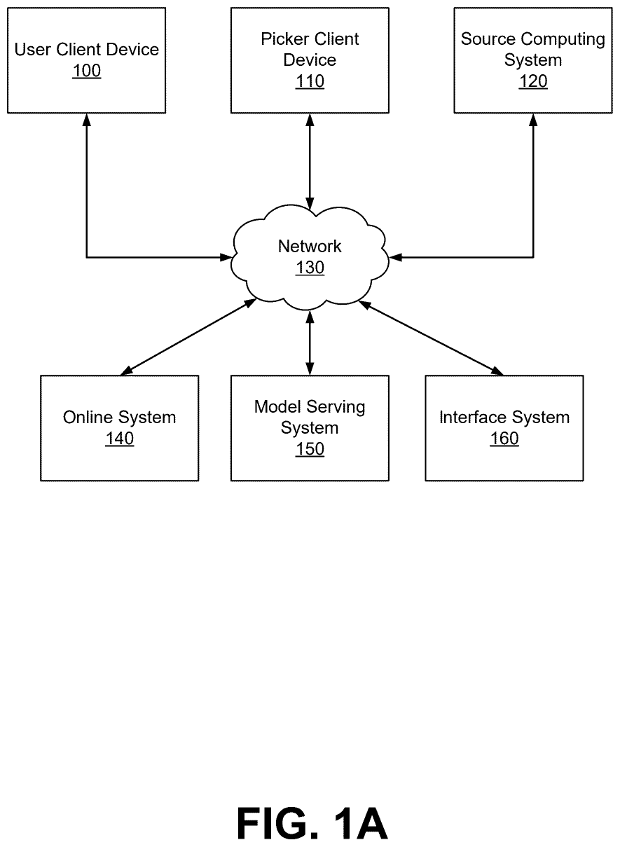

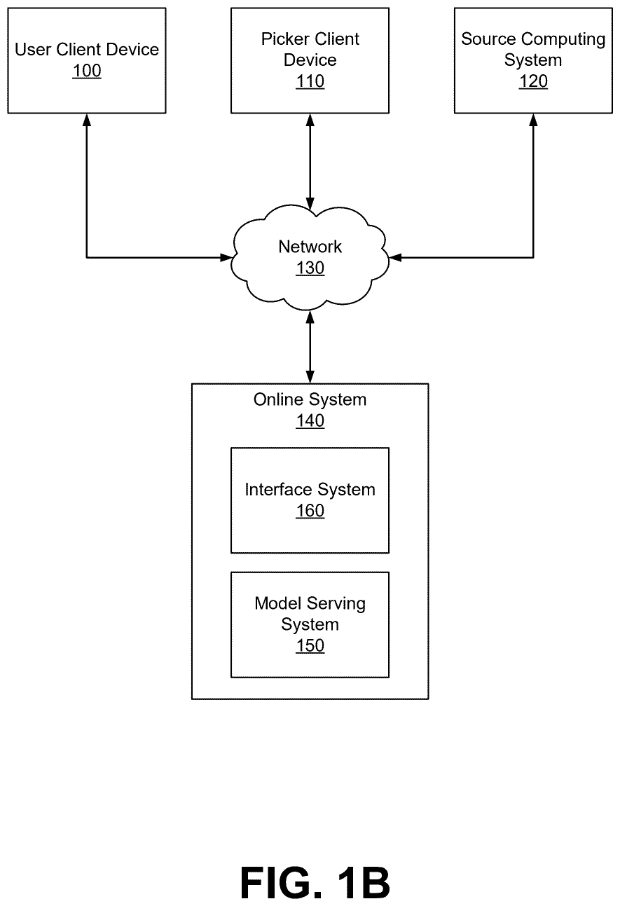

FIG. 1A illustrates an example system environment for an online system 140, in accordance with one or more embodiments. The system environment illustrated in FIG. 1A includes a user client device 100, a picker client device 110, a source computing system 120, a network 130, an online system 140, a model serving system 150, and an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with an agent that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker (also referred to herein as a servicing agent, or agent) services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 trains a machine-learning model to predict, for a given user and item, the user's consumption of the item over a specific time period (e.g., next week, or until a next resupply trip). To train the machine-learning model, the online system 140 obtains input features about user's consumption of various items. The input features may be obtained, e.g., from images of the user's food storage, images of the user's trash, and data with information about the user's purchase history. Once trained, the online system 140 deploys the machine-learning model to predict usage rates for user-item pairs, and those predictions are subsequently used to make suggestions to users. For example, a user may ask the online system 140 about whether they need more butter. In response, the online system 140 parses the question, applies the trained machine-learning model to predict the user's future consumption of butter, compares the prediction to the user's current inventory, and then responds with a suggestion to the user about whether to acquire more butter.

The online system 140 presented herein creates a personalized pantry and usage rate that can intelligently deduce the rate at which a user goes through specific items in their house inventory. The usage rate is not only specific to pantry items but could also be for any other item that the user purchases or has a supply of (e.g., items residing in their refrigerator). The online system 140 trains a machine-learning model that predicts a user's usage rates of various grocery items or other consumables over time, based on images of the user's food storage (e.g., refrigerator), trash, as well as their shopping history. The predicted user's usage rate of a specific item can be leveraged in numerous aspects throughout an omni-channel of the online system 140 to create an improved shopping experience for users, as well as to improve the batch delivery for pickers. For example, the online system 140 may automatically prompt the user when they add an item to their cart that the item will expire before they finish the item based on their usage rate.

The model serving system 150 receives requests from the online system 140 to perform tasks using machine-learning models. The tasks include, but are not limited to, natural language processing (NLP) tasks, audio processing tasks, image processing tasks, video processing tasks, and the like. In one or more embodiments, the machine-learning models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM, the LLM is able to perform various tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While an LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

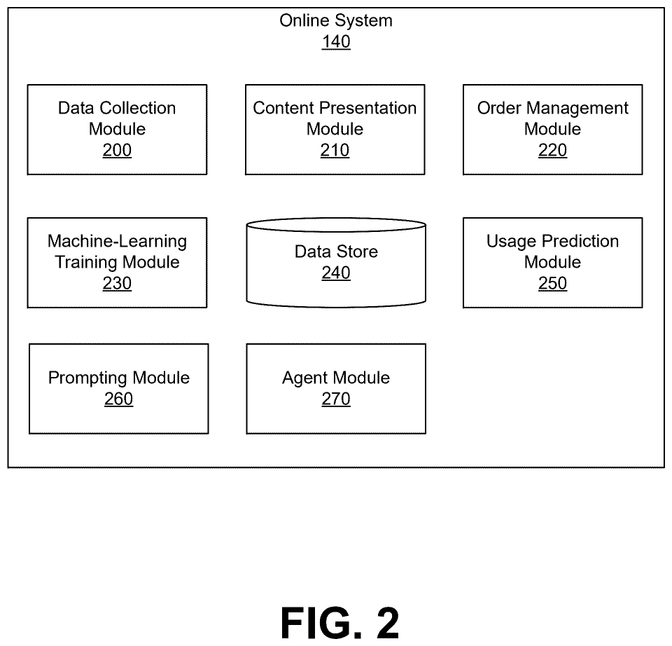

The online system 140 may employ an LLM of the model serving system 150 to parse a query from a user of the online system 140 in relation to a user's need for a specific item. The online system 140 may prepare (e.g., via a prompting module 260 in FIG. 2) a prompt for input to the LLM. The prompt may include the query from the user about the user's need for the specific item. The LLM may generate a response to the prompt based on execution of the machine-learning model using the prompt. The response may include structured information about the query extracted by the LLM. The online system 140 may import the response from the model serving system 150 and use the response as an input signal to the machine-learning model that is trained to predict a rate of using the item by the user.

In one or more embodiments, the task for the model serving system 150 is based on knowledge of the online system 140 that is fed to the machine-learning model of the model serving system 150, rather than relying on general knowledge encoded in the model weights of the model. Thus, one objective may be to perform various types of queries on the external data in order to perform any task that the machine-learning model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine-learning language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a usage prediction module 250, a prompting module 260, and an agent module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In one or more embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In one or more embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In one or more embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learning models hosted by the model serving system 150, the machine-learning models may already be trained by a separate entity from the entity responsible for the online system 140. In one or more other embodiments, when the model serving system 150 is included in the online system 140, the machine-learning training module 230 may further train parameters of the machine-learning model based on data specific to the online system 140 stored in the data store 240. As an example, the machine-learning training module 230 may obtain a pre-trained transformer language model and further fine tune the parameters of the transformer language model using training data stored in the data store 240. The machine-learning training module 230 may provide the transformer language model to the model serving system 150 for deployment.

The usage prediction module 250 may access a usage prediction model (e.g., machine-learning model) that is trained to predict a rate of using an item by a user of the online system 140. The usage prediction module 250 may deploy the usage prediction model to run a machine-learning algorithm to input signals to output a fulfillment date, i.e., a date when the item will need to be refilled. The usage prediction module 250 may extrapolate information about the fulfillment date to deduce a usage quantity per unit time for the item. A set of parameters for the usage prediction model may be stored at one or more non-transitory computer-readable media of the usage prediction module 250. Alternatively, the set of parameters for the usage prediction model may be stored at one or more non-transitory computer-readable media of the data store 240.

The usage prediction model may be a multimodal machine-learning model that leverages a variety of input signals (i.e., input signals of different modalities) to generate a personalized usage rate for a specific item. In providing the input signals to the usage prediction model, the usage prediction module 250 may provide images of an inside of user's refrigerator, images of user's food storage, images of user's trash bins, images of user's recycle bins, data with information about the user's shopping history, data derived from the user's shopping history (e.g., expiration dates of items that are in user's possession), some other data, or some combination thereof. The various images may be taken by the user over time (e.g., at specific time intervals or weekly) via one or more cameras of the user client device 100 and uploaded via the network 130 to the online system 140 and the usage prediction module 250. If the user possesses a smart refrigerator, images of an inside of the smart refrigerator are available in real time and may be communicated in real time via the network 130 to the online system 140 and the usage prediction module 250. Additionally, the usage prediction module 250 may retrieve information about the user's shopping history from a user catalog database (e.g., stored at the data store 240). Note that all of these is being done with the user's explicit consent and opt-in, and in compliance with any applicable privacy laws, regulations, and/or rules.

Initial images uploaded from the user client device 100 to the online system 140 may provide information about dimensions of the user's refrigerator and user's food storage (e.g., user's pantry). The usage prediction model (or the usage prediction module 250) may leverage these initial images to deduce how many other items could fit within these physical spaces of the user. Later images uploaded from the user client device 100 to the online system 140 may provide information about a rate at how quickly the user consumes specific items. For example, the usage prediction module 250 can infer that the user consumes Item A at a rate of X based on the decrease in their stock over Y weeks.

To generate the input signals for the usage prediction model, the usage prediction module 250 may combine these uploaded images with information about the user's transaction history and imagery captured by one or more cameras of a smart shopping cart of expiration dates of items as the items are placed in the smart shopping cart in a source location. The user's transaction history may represent a primary core input for the usage prediction model, whereas other input signals (e.g., contextual image input and storage sizing) may be secondary weighted inputs. It should be noted that some quantities of items need to be normalized, such that the user, for example, consumes 250 g of butter, not 1 package.

An important nuance is determining which replacements are actual substitutes for each other when it comes to consumption rates. The usage prediction model may produce consumption rates for taxonomy nodes, such as “X sheets/week in node Toilet Paper”. However, this would not always be produced all the way down to the leaf nodes. Determination on how far down the taxonomy nodes usage prediction model goes, and on what branches of the taxonomy tree may be custom per user.

In the absence of images or dimensions of a user's storage space, the usage prediction module 250 may be able to infer a user's storage capacity by using the following algorithm. Once the online system 140 has the knowledge about a set of items that the user has purchased over a given time window, and a rate of consumption for the set of items, the usage prediction module 250 may estimate what items and how much of the items the user has at any given point in time in their storage space. From this information, the usage prediction module 250 may derive an estimate about how much storage space the user is using by taking into account that set of items and the knowledge of their volume and presumed storage locations.

In one or more embodiments, the usage prediction model is utilized as a translation layer to bundle and cluster items together. The output from the usage prediction model may be utilized for estimating the user's inventory at an equivalency point. For example, salted butter and unsalted butter may be in a cluster where both Brand A butter and Brand B butter would both fall under salted butter. Users may manually override these if they care about having one item as a staple item while the other item is a specialty item.

The machine-learning training module 230 may perform initial training of the usage prediction model using training data. The machine-learning training module 230 may generate the training data that include information about a user's personalized consumption rate after the user supplies the online system 140 with initial images of their pantry and refrigerator. The training data may further include information about the user's past purchases and the rates at which the user purchased certain items over time. The machine-learning training module 230 may exclude from the training data information about purchases that are deemed to be outside of normal usage. For example, if the online system 140 determines that certain purchases were part of a special event (e.g., birthday party or a large hosting event), the user's consumption related to these “special event purchases” may not be incorporated into the user's regular consumption rates as part of the training data. This exclusion may be applied only to items that are bought frequently. The machine-learning training module 230 may train the usage prediction model using the training data to generate initial values for the set of parameters of the usage prediction model.

The machine-learning training module 230 may collect feedback data with information about whether the user adds items to their cart from prompts generated by the LLM and the agent module 270 that are presented to the user via a user interface of the user client device 100 (e.g., when the user is shopping), information about the user's engagement with Buy-It-Again (BIA) items, information about user's engagements at any other surfaces where the personalized user consumption rate is integrated, or some combination thereof. Additionally or alternatively, if the user manually adds items to the cart after adding items from a recipe (where only those items are add the user needs to stock up on), this information may be recorded and included into the feedback data for reinforcement of the usage prediction model. The feedback data may be recorded at the user client device 100 and communicated, via the network 130, to the online system 140 and the machine-learning training module 230. The machine-learning training module 230 may then re-train the usage prediction model by updating the set of parameters of the usage prediction model using the feedback data.

In one or more embodiments, the online system 140 utilizes an LLM (e.g., LLM of the model serving system 150) to generate structured information about a user's query in relation to the user's need for a specific item. The prompting module 260 may generate a prompt for input into the LLM, where the prompt may include a query about the user's needs for a specific item (e.g., “do I need more butter?”). An output generated by the LLM may include structured information about the query extracted by the LLM. The output generated by the LLM may be imported at the online system 140 and passed, via the usage prediction module 250, as an input signal to the usage prediction model. The usage prediction module 250 may then obtain data about the user's existing inventory, e.g., images of food storage, or inferred based on the user's transaction information. The usage prediction module 250 may apply the usage prediction model to the structured information about the user's query and the user's existing inventory data to predict a usage of the specific item.

The usage prediction module 250 may compute any shortfall (or surplus) with the existing inventory in relation to the specific item. If there is a shortfall in the predicted demand for the specific item, the content presentation module 210 may generate a user interface signal with information about the specific item. The content presentation module 210 may send, via the network 130, the user interface signal to the user client device 100 causing the user client device 100 to display a user interface with a user interface element prompting the user to add the specific item to the cart.

It should be noted that one major benefit of having the usage prediction model integrated into the online system 140 is not using conventional means to predict a user's usage of items from their purchase history. This conventional approach fails to capture items that the user buys and consumes outside of the online system 140. Instead, the usage prediction model captures the consumption of items that were not acquired via the online system 140.

The agent module 270 may provide for an artificial intelligence (AI) integration with the output of the usage prediction model. The agent module 270 may operate as an omni-channel shopping assistant that is also integrated with the voice AI of the online system 140. For example, the user can utilize a user interface of the user client device 100 to ask “Do I need more butter?”, and rather than replying as “You have 8 oz of butter remaining,” the agent module 270 may generate a more human-nuanced reply, such as “You have plenty of butter, probably a couple weeks'worth unless you have any big baking projects.”

In one or more embodiments, the agent module 270 can capture metadata associated with the user's voice input, tone, and sentiment to better respond to the user. For example, the user may ask “How much of the butter do I have in the fridge?”. Then, the agent module 270 may generate a response with a correct answer but recognizing that the user has two types of butter in the refrigerator, and one is much more expensive per unit size than the other.

Furthermore, a user of the online system 140 can also discuss with the agent module 270 about the user's personalized pantry scores and items. In particular, the users can leverage AI functionality of the agent module 270 to ask about the stock level of certain items within the user's premises. For example, the user may ask “Hey, what's the current stock level of butter in my freezer”. Alternatively, the user may hit a button on a user interface of the smart shopping cart that is automatically prompted. By analyzing images of the user's refrigerator and based on a usage rate generated by the usage prediction model, the usage prediction module 250 may estimate the current stock level of butter. Using information about the estimated current stock level, the agent module 270 may generate a corresponding response to the user's question that is then displayed at a user interface of the user client device 100 or a user interface of the smart shopping cart.

A personalized usage rate generated by the usage prediction model can be leveraged to improve the user's shopping experience at the online system 140. For example, based on a usage rate generated by the usage prediction model, the online system 140 may know that a specific item (e.g., milk) in the user's refrigerator will be fully consumed soon (or will be expiring soon). The user also did not add this item to a cart. While the picker is walking by a corresponding aisle (e.g., milk aisle), the agent module 270 may automatically generate a prompt for displaying at a user interface of the user client device 100, such as “We noticed that you're out of milk (or it's expiring soon)-do you want to add it to your cart?” Alternatively, as the picker adds items during their picking session, the usage prediction module 250 may infer, based on a usage rate generated by the usage prediction model, that one of the items has an expiry date earlier than when the user would consume that item. The content presentation module 210 may generate a corresponding user interface signal to flag this to the picker at a user interface of the picker client device 110 so that the picker can try and find a longer expiry date or to refund the item.

It is quite common for users to forget what they do and do not have in their food storage. Thus, when a user of the online system 140 is shopping in a source location (either using the smart shopping cart or an in-store mode of the application running on the user client device 100) and walks by an item, the usage prediction module 250 may determine, based on a predicted usage rate for the item from now until a next shopping trip, whether the user will be soon out of the item. If so, the content presentation module 210 may generate a corresponding user interface signal causing the user client device 100 to display a user interface that prompts the user to add the item to a current order to restock the item. This prompt may be particularly effective when certain items that are predicted to be soon fully consumed by the user are currently on sale. Additionally, this can be leveraged to increase the incremental gross transaction value (GTV) of the user during the user's shopping trips.

On the online side of the omni-channel, the online system 140 can create a whole new category of “stock up” or “running low” categories where the user can see items that they need to stock up on. Users may also opt-in to an automated re-ordering of these items, or categories, that they are running low on. For example, the user can opt into categories such as “milk”, “eggs”, “bread”, etc. In such cases, the online system 140 may manage replacements based on the user's past conversion history. By utilizing integration with the LLM, the agent module 270 (or some other module of the online system 140) may provide responses such as, “We got you your second-choice milk since the 2% wasn't available this time”, or “The milk was on sale and you had the space in your storage pantry, and the expiry date was 2 weeks out, so we bought you 2 gallons this time.”

In one or more embodiments, personalized usage rates for various items generated by the usage prediction model can be leveraged for coupon generations. If there is a space in food storage and needs for particular items, the content presentation module 210 (or some other module of the online system 140) may generate coupons or other promotions for these items. Personalized usage rates generated by the usage prediction model may be utilized to on-demand spin up real-time personalized coupons that the user could utilize during their shopping trips. For example, while the user is online shopping or while the user is shopping using the smart shopping cart in a source location, the content presentation module 210 may prompt the user with a notification, such as “Hey you're running low on butter-here's 15% off”. Or if the user has space to buy two quantities of an item given their pantry space, the content presentation module 210 may prompt the user with a notification, such as “We see you have space in your pantry for two bags of flour—here's a BOGO.” The usage prediction model may also utilize, e.g., a weekly flyer as an input to facilitate providing meaningful coupons for users.

The online system 140 allows users to add items to their cart from recipes. In such cases, when a user of the online system 140 is shopping for recipe ingredients, the content presentation module 210 may utilize personalized usage rates generated by the usage prediction model to inform the user that there is no need to buy certain items if they are all in stock. The content presentation module 210 may generate a user interface signal causing the user client device 100 to display a user interface where items that are in stock at the user's premises are grayed out, have partially lower the opacity, or a green checkmark emoji is put beside these items.

In one or more embodiments, personalized usage rates for various items generated by the usage prediction model can be leveraged to nudge users to buy items using the online system 140. Many users of the online system 140 often consume items that were not purchased using the online system 140. The online system 140 may utilize the usage prediction model to generate an offer for a user of the online system 140 to buy a certain item using the online system 140, where that item was not previously purchased via the online system 140. For example, based on various input signals of the usage prediction model (e.g., images of food in the refrigerator or pantry), the online system 140 can infer that the user purchased some relatively expensive items (e.g., high-end cheeses), but not via the online system 140. In such cases, the content presentation module 210 may generate a user interface signal with an offer for the user to buy those same items (e.g., the same cheeses) via the online system 140 from one of sources associated with the online system 140 from which the user does not currently shop.

In one or more embodiments, personalized usage rates for various items generated by the usage prediction model can be used as input features for other trained machine-learning models. For example, the personalized usage rates output by the usage prediction model may be used to generate an indication of user-item specific demand feature for use by other ranking/scoring machine-learning models, such as a trained machine-learning model that predicts a lifetime value (LTV) for a user-item pair.

In one or more embodiments, personalized usage rates for various items generated by the usage prediction model can be used to facilitate improvements in relation to BIA carousels. Typically, a user's BIA list can be large, e.g., between 100 and 200 items for high consumption users. Information about items'usage rates generated by the usage prediction model may be utilized by the content presentation module 210 to improve the ranking of those BIA items and create a more engaging BIA list. If the online system 140 identifies with high confidence that the user has particular BIA items, the online system 140 may opt to not show those items first in the BIA carousel.

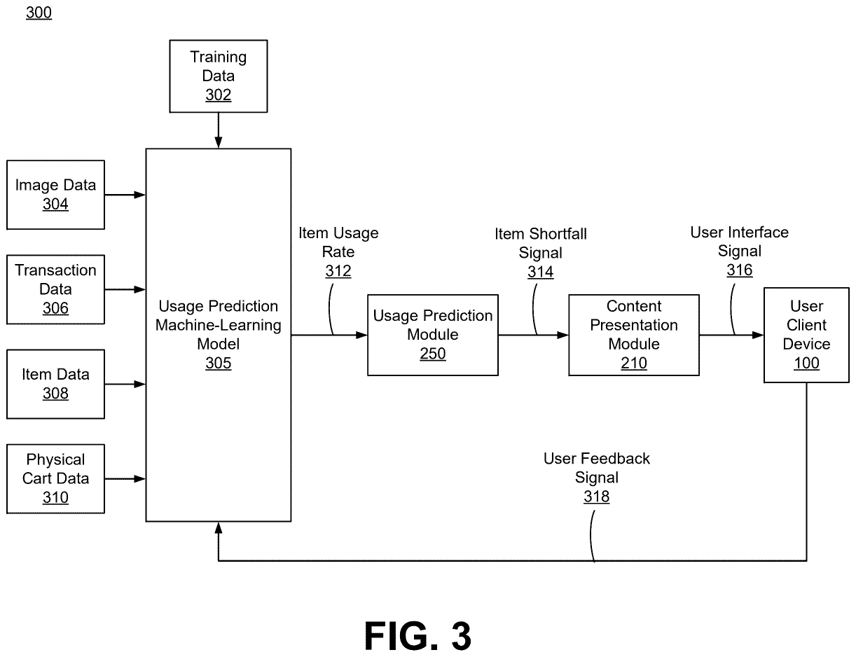

FIG. 3 illustrates an example architectural flow diagram 300 of training and applying a usage prediction machine-learning model 305 to predict a rate of using an item by a user of the online system 140, in accordance with one or more embodiments. Prior to running a machine-learning algorithm of the usage prediction machine-learning model 305, the online system 140 may perform (e.g., via the machine-learning training module 230) initial training of the usage prediction machine-learning model 305 using training data 302 to generate initial values for a set of parameters of the usage prediction machine-learning model 305. The machine-learning training module 230 may generate the training data 302 with training examples that include training set of images of physical spaces (e.g., refrigerators, pantries, trash bins, recycle bins, etc.) of a training set of users of the online system 140 that store a collection of items, and conversion data including information about conversion of the collection of items by the training set of users. Each training example that is part of the training data 302 may include one or more training images from the training set of images associated with a respective training user from the training set of users that are related to a respective item from the collection of items, and a portion of the conversion data related to conversion of the respective item by the respective training user. After the training process is completed, the online system 140 may provide one or more inputs to the usage prediction machine-learning model 305 (e.g., via the usage prediction module 250), such as image data 304, transaction data 306, item data 308, and/or physical cart data 310. Some additional inputs not shown in FIG. 3 may be further provided to the usage prediction machine-learning model 305.

In providing the image data 304 to the usage prediction machine-learning model 305, the usage prediction module 250 may provide one or more images of inside portions of one or more physical spaces (e.g., refrigerator, pantry, trash bin, recycle bin, etc.) of a given user of the online system 140, where the one or more physical spaces store a plurality of items. The usage prediction module 250 may receive the image data 304 from one or more devices associated with the user (e.g., the user client device 100, a smart refrigerator, etc.) via the network 130. Alternatively, the usage prediction module 250 may retrieve the image data 304 from a user catalog database (e.g., part of the data store 240).

In providing the transaction data 306 to the usage prediction machine-learning model 305, the usage prediction module 250 may provide information about how often the user converts on a specific item, various data derived from the user's conversion history (e.g., expiration date of the item that is in user's possession), some other data, or some combination thereof. The usage prediction module 250 may retrieve the transaction data 306 from an order catalog database (e.g., part of the data store 240).

In providing the item data 308 to the usage prediction machine-learning model 305, the usage prediction module 250 may provide information about one or more features of the item, such as a taxonomy (i.e., classification) of the item, perishability of the item, expiration date of the item, some other features of the item, or some combination thereof. The usage prediction module 250 may retrieve the item data 308 from an item catalog database (e.g., part of the data store 240), or may derive the item data 308 from data retrieved from the item catalog database.

In providing the physical cart data 310 to the usage prediction machine-learning model 305, the usage prediction module 250 may provide information about the item collected via one or more sensors of the smart shopping cart that the user utilizes for shopping in a source location, information that the user is passing by an aisle with the item, some other data collected by the smart shopping cart at the source location, or some combination thereof. The usage prediction module 250 may receive the physical cart data 310 from the smart shopping cart via the network 130.

The usage prediction machine-learning model 305 may apply the machine-learning algorithm to the image data 304, the transaction data 306, the item data 308, and/or the physical cart data 310 to predict an item usage rate 312 that represents a rate of using the item by the user over a time period (e.g., until the next conversion session). The usage prediction machine-learning model 305 may pass the item usage rate 312 to the usage prediction module 250. The usage prediction module 250 may use the item usage rate 312 and information about a current user's inventory of the item (e.g., derived from the image data 304 and/or the transaction data 306) to generate an item shortfall signal 314 indicating that the user will be without the item before the next user's conversion session at the online system 140. The usage prediction module 250 may pass the item shortfall signal 314 to the content presentation module 210.

The content presentation module 210 may generate, using the item shortfall signal 314, a user interface signal 316. The content presentation module 210 may communicate, via the network 130, the user interface signal 316 to the user client device 100 (or alternatively to the smart shopping cart utilized by the user at the source location). The user interface signal 316 may cause the user client device (or the smart shopping cart) to display a user interface with a user interface element for use by the user to order the item, or with a message for the user prompting the user to add the item to the smart shopping cart.

The user client device 100 (or the smart shopping cart) may generate and record a user feedback signal 318 including information about whether the user ordered the item (or whether the user added the item to the smart shopping cart). The online system 140 may receive (e.g., via the machine-learning training module 230) the user feedback signal 318 from the user client device 100 (or the smart shopping cart) via the network 130. The machine-learning training module 230 may utilize the user feedback signal 318 to re-train the usage prediction machine-learning model 305. By utilizing user feedback signals 318 provided by various users over time, the machine-learning training module 230 may continuously update the set of parameters of the usage prediction machine-learning model 305 and continuously improve the machine-learning algorithm of the usage prediction machine-learning model 305.

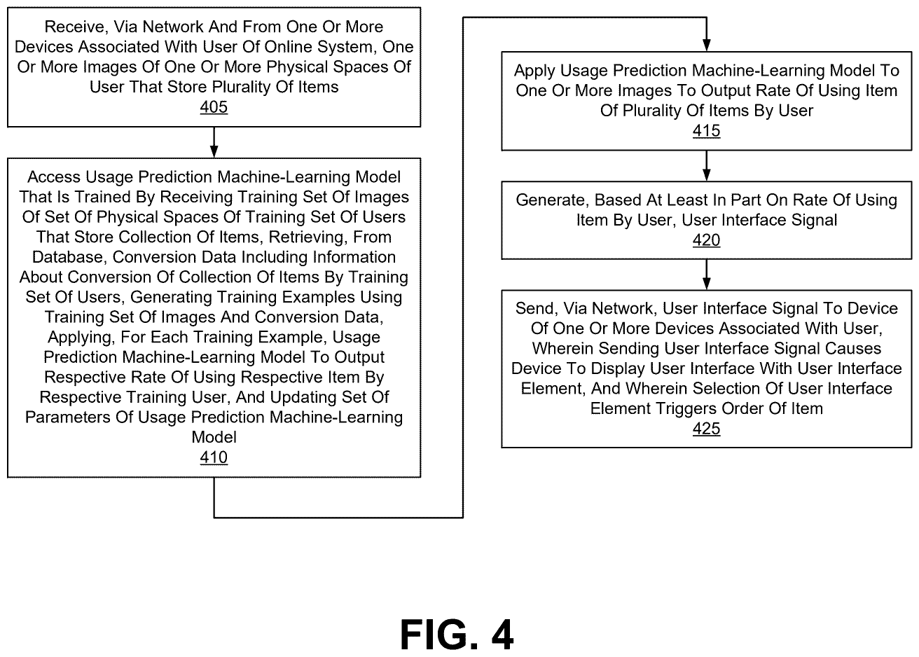

FIG. 4 is a flowchart for a method of training and utilizing a machine-learning model to predict a rate of using an item by a user of an online system, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 receives 405 (e.g., at the usage prediction module 250), via a network (e.g., the network 130) and from one or more devices associated with a user of the online system 140 (e.g., the user client device 100 and/or a smart refrigerator), one or more images of one or more physical spaces (e.g., refrigerator, pantry, trash bin, recycle bin, etc.) of the user that store a plurality of items.

The online system 140 accesses 410 (e.g., via the usage prediction module 250) a usage prediction machine-learning model of the online system 140. The online system 140 trains the usage prediction machine-learning model (e.g., via the machine-learning training module 230 and/or the usage prediction module 250) by: receiving, via the network and from a set of devices associated with a training set of users of the online system 140 (e.g., user client devices 100), a training set of images of a set of physical spaces (e.g., refrigerators, pantries, trash bins, recycle bins, etc.) of the training set of users that store a collection of items; retrieving, from a database of the online system 140 (e.g., the data store 240), conversion data including information about conversion of the collection of items by the training set of users; generating a plurality of training examples using the training set of images and the conversion data, each of the plurality of training examples including one or more training images from the training set of images associated with a respective training user from the training set of users that are related to a respective item from the collection of items, and a portion of the conversion data related to conversion of the respective item by the respective training user; for each of the plurality of training examples, applying the usage prediction machine-learning model to output a respective rate of a plurality of rates of using the respective item by the respective training user; and updating, for each of the plurality of training examples and based on the plurality of rates, a set of parameters of the usage prediction machine-learning model.

The online system 140 applies 415 the usage prediction machine-learning model (e.g., via the usage prediction module 250) to the one or more images to output a rate of using an item of the plurality of items by the user. The online system 140 generates 420 (e.g., via the content presentation module 210), based at least in part on the rate of using the item by the user, a first user interface signal. The online system 140 sends 425 (e.g., via the content presentation module 210), via the network, the first user interface signal to a device of the one or more devices associated with the user (e.g., the user client device 100), wherein the sending the first user interface signal causes the device to display a user interface with a user interface element, and wherein selection of the user interface element triggers an order of the item.

The online system 140 may retrieve (e.g., via the usage prediction module 250), from the database, transaction information in relation to conversions of the item by the user. The online system 140 may apply the usage prediction machine-learning model (e.g., via the usage prediction module 250) further to the transaction information to output the rate of using the item by the user. The online system 140 may identify (e.g., via the usage prediction module 250), based on the transaction information and the rate of using the item, that the user will be without the item before a next conversion session at the online system 140. Responsive to identifying that the user will be without the item before the next conversion session, the online system 140 may generate (e.g., via the content presentation module 210) the first user interface signal.

The online system 140 may receive (e.g., at the order management module 220), via the network from the device associated with the user, a signal including a query from the user in relation to a need for a second item of the plurality of items. Responsive to receiving the signal, the online system 140 may generate (e.g., via the prompting module 260) a prompt for input into a language model (e.g., LLM of the model serving system 150), the prompt including the query and a request for the language model to extract, from the query, structured information about the query. The online system 140 may request (e.g., via the prompting module 260) the language model to generate, based on the prompt input into the language model, a response including the structured information about the query. The online system 140 may apply the usage prediction machine-learning model (e.g., via the usage prediction module 250) to the response from the language model and information about an existing inventory of the user in relation to the second item to output a rate of using the second item by the user. The online system 140 may identify (e.g., via the usage prediction module 250), based on the information about the existing inventory and the rate of using the second item, the need for the second item. Responsive to identifying the need for the second item, the online system 140 may generate (e.g., via the content presentation module 210 or the agent module 270) a second user interface signal. The online system 140 may send (e.g., via the content presentation module 210 or the agent module 270), via the network, the second user interface signal to the device associated with the user, wherein the sending the second user interface signal causes the device to display the user interface with a message about the need for the second item and a second user interface element for use by the user to order the second item.

The online system 140 may receive (e.g., at the usage prediction module 250) the one or more images including the information about the existing inventory of the user in relation to the second item. Alternatively, the online system 140 may retrieve (e.g., via the usage prediction module 250), from the database, transaction information in relation to conversions of the second item by the user. In such cases, the online system 140 may infer (e.g., via the usage prediction module 250), based on the transaction information, the information about the existing inventory of the user in relation to the second item.

The online system 140 may receive (e.g., at the usage prediction module 250), from the device associated with the user and via the network, a location signal indicating that the user is in a vicinity of a second item of the plurality of items. Responsive to receiving the location signal, the online system 140 may apply the usage prediction machine-learning model (e.g., via the usage prediction module 250) to the one or more images to output a rate of using the second item by the user. Responsive to receiving the location signal, the online system 140 may retrieve (e.g., via the usage prediction module 250), from the database, transaction information in relation to conversions of the second item by the user. The online system 140 may identify (e.g., via the usage prediction module 250), based on the transaction information and the rate of using the second item, that the user will be without the second item before a next conversion session at the online system 140. Responsive to identifying that the user will be without the second item before the next conversion session, the online system 140 may generate (e.g., via the content presentation module 210) a second user interface signal. The online system 140 may send (e.g., via the content presentation module 210), via the network, the second user interface signal to the device associated with the user, wherein the sending the second user interface signal causes the device to display the user interface with a message about a need by the user for the second item and a second user interface element for use by the user to order the second item.

The online system 140 may identify (e.g., via the usage prediction module 250), based on the one or more images, that the one or more physical spaces are able to store the second item. Responsive to identifying that the one or more physical spaces are able to store the second item and that the user will be without the second item before the next conversion session, the online system 140 may generate (e.g., via the content presentation module 210) a third user interface signal with information about a promotion for ordering the second item. The online system 140 may send (e.g., via the content presentation module 210), via the network, the third user interface signal to the device associated with the user, wherein the sending the third user interface signal causes the device to display the user interface further with the information about the promotion for ordering the second item.

The online system 140 may receive (e.g., at the order management module 220), from the device associated with the user and via the network, a request for a list of items related to a list of ingredients. Responsive to receiving the request, the online system 140 may apply the usage prediction machine-learning model (e.g., via the usage prediction module 250) to the one or more images to output a rate of using each item from the list of items by the user. The online system 140 may identify (e.g., via the usage prediction module 250), based on the rate of using each item from the list of items and the one or more images, that the user is in possession of a sufficient quantity of one or more items from the list of items. Responsive to identifying that the user is in the possession of the sufficient quantity of the one or more items, the online system 140 may generate (e.g., via the content presentation module 210) a second user interface signal. The online system 140 may send (e.g., via the content presentation module 210), via the network, the second user interface signal to the device associated with the user, wherein the sending the second user interface signal causes the device to display the user interface with a message informing the user that the user is in the possession of the sufficient quantity of the one or more items.

The online system 140 may retrieve (e.g., via the usage prediction module 250), from the database, transaction information in relation to conversions of a set of items by the user at the online system 140. The online system 140 may identify (e.g., via the usage prediction module 250), based on the one or more images and the transaction information, a second item used by the user that was converted by the user outside of the online system 140. Responsive to identifying the second item, the online system 140 may apply the usage prediction machine-learning model (e.g., via the usage prediction module 250) to the one or more images to output a rate of using the second item by the user. The online system 140 may identify (e.g., via the usage prediction module 250), based on the one or more images and the rate of using the second item, a need by the user for the second item. Responsive to identifying the need for the second item, the online system 140 may generate (e.g., via the content presentation module 210) a second user interface signal. The online system 140 may send (e.g., via the content presentation module 210), via the network, the second user interface signal to the device associated with the user, wherein the sending the second user interface signal causes the device to display the user interface with a message about the need for the second item and a second user interface element for use by the user to order the second item.

The online system 140 may infer (e.g., via the machine-learning training module 230), using the information about conversion of the collection of items by the training set of users, a conversion rate at which each user from the training set of users converts on each item of the collection of items. The online system 140 may train (e.g., via the machine-learning training module 230), using the training set of images and the conversion rate at which each user converts on each item of the collection of items, the usage prediction machine-learning model to generate a set of initial values for the set of parameters of the usage prediction machine-learning model. The online system 140 may store (e.g., via the machine-learning training module 230) the set of initial values for the set of parameters of the usage prediction machine-learning model to a computer-readable medium of the online system 140 (e.g., of the data store 240 or the usage prediction module 250).

The online system 140 may collect (e.g., via the machine-learning training module 230) feedback data with information about whether the user ordered the item. The online system 140 may re-train the usage prediction machine-learning model by updating (e.g., via the machine-learning training module 230), using the feedback data, the set of parameters of the usage prediction machine-learning model.

Embodiments of the present disclosure are directed to the online system 140 that trains and utilizes a multimodal machine-learning model to predict a usage rate of an item for a user of the online system 140. The machine-learning model is trained to predict usage rates for user-item pairs, where the machine-learning model is trained on data acquired out of band (e.g., images of users'food storages, refrigerators, trash bins, etc.). Various use cases are presented herein for making suggestions to users of the online system 140 based on the prediction generated by the trained machine-learning model.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, via a network and from one or more devices associated with a user of an online system, one or more images of one or more physical spaces of the user that store a plurality of items;
accessing a usage prediction machine-learning model of the online system, wherein the usage prediction machine-learning model is trained by:
receiving, via the network and from a set of devices associated with a training set of users of the online system, a training set of images of a set of physical spaces of the training set of users that store a collection of items,
retrieving, from a database of the online system, conversion data including information about conversion of the collection of items by the training set of users,
generating a plurality of training examples using the training set of images and the conversion data, each of the plurality of training examples including one or more training images from the training set of images associated with a respective training user from the training set of users that are related to a respective item from the collection of items, and a portion of the conversion data related to conversion of the respective item by the respective training user,
for each of the plurality of training examples, applying the usage prediction machine-learning model to output a respective rate of a plurality of rates of using the respective item by the respective training user, and
updating, for each of the plurality of training examples and based on the plurality of rates, a set of parameters of the usage prediction machine-learning model;
applying the usage prediction machine-learning model to the one or more images to output a rate of using an item of the plurality of items by the user;
generating, based at least in part on the rate of using the item by the user, a first user interface signal; and
sending, via the network, the first user interface signal to a device of the one or more devices associated with the user, wherein the sending the first user interface signal causes the device to display a user interface with a user interface element, and wherein selection of the user interface element triggers an order of the item.

2. The method of claim 1, further comprising:
retrieving, from the database, transaction information in relation to conversions of the item by the user,
wherein applying the usage prediction machine-learning model comprises applying the usage prediction machine-learning model further to the transaction information to output the rate of using the item by the user.

3. The method of claim 2, further comprising:
identifying, based on the transaction information and the rate of using the item, that the user will be without the item before a next conversion session at the online system; and
responsive to identifying that the user will be without the item before the next conversion session, generating the first user interface signal.

4. The method of claim 1, further comprising:
receiving, via the network and from the device associated with the user, a signal including a query from the user in relation to a need for a second item of the plurality of items;
responsive to receiving the signal, generating a prompt for input into a language model, the prompt including the query and a request for the language model to extract, from the query, structured information about the query;
requesting the language model to generate, based on the prompt input into the language model, a response including the structured information about the query;
applying the usage prediction machine-learning model to the response from the language model and information about an existing inventory of the user in relation to the second item to output a rate of using the second item by the user;
identifying, based on the information about the existing inventory and the rate of using the second item, the need for the second item;
responsive to identifying the need for the second item, generating a second user interface signal; and
sending, via the network, the second user interface signal to the device associated with the user, wherein the sending the second user interface signal causes the device to display the user interface with a message about the need for the second item and a second user interface element for use by the user to order the second item.

5. The method of claim 4, wherein receiving the one or more images comprises:
receiving the one or more images including the information about the existing inventory of the user in relation to the second item.

6. The method of claim 4, further comprising:
retrieving, from the database, transaction information in relation to conversions of the second item by the user; and
inferring, based on the transaction information, the information about the existing inventory of the user in relation to the second item.

7. The method of claim 1, further comprising:
receiving, from the device associated with the user and via the network, a location signal indicating that the user is in a vicinity of a second item of the plurality of items;
responsive to receiving the location signal, applying the usage prediction machine-learning model to the one or more images to output a rate of using the second item by the user;
responsive to receiving the location signal, retrieving, from the database, transaction information in relation to conversions of the second item by the user;
identifying, based on the transaction information and the rate of using the second item, that the user will be without the second item before a next conversion session at the online system;
responsive to identifying that the user will be without the second item before the next conversion session, generating a second user interface signal; and
sending, via the network, the second user interface signal to the device associated with the user, wherein the sending the second user interface signal causes the device to display the user interface with a message about a need by the user for the second item and a second user interface element for use by the user to order the second item.

8. The method of claim 7, further comprising:
identifying, based on the one or more images, that the one or more physical spaces are able to store the second item;
responsive to identifying that the one or more physical spaces are able to store the second item and that the user will be without the second item before the next conversion session, generating a third user interface signal with information about a promotion for ordering the second item; and
sending, via the network, the third user interface signal to the device associated with the user, wherein the sending the third user interface signal causes the device to display the user interface further with the information about the promotion for ordering the second item.

9. The method of claim 1, further comprising:
receiving, from the device associated with the user and via the network, a request for a list of items related to a list of ingredients;
responsive to receiving the request, applying the usage prediction machine-learning model to the one or more images to output a rate of using each item from the list of items by the user;
identifying, based on the rate of using each item from the list of items and the one or more images, that the user is in possession of a sufficient quantity of one or more items from the list of items;
responsive to identifying that the user is in the possession of the sufficient quantity of the one or more items, generating a second user interface signal; and
sending, via the network, the second user interface signal to the device associated with the user, wherein the sending the second user interface signal causes the device to display the user interface with a message informing the user that the user is in the possession of the sufficient quantity of the one or more items.

10. The method of claim 1, further comprising:
retrieving, from the database, transaction information in relation to conversions of a set of items by the user at the online system;
identifying, based on the one or more images and the transaction information, a second item used by the user that was converted by the user outside of the online system;
responsive to identifying the second item, applying the usage prediction machine-learning model to the one or more images to output a rate of using the second item by the user;
identifying, based on the one or more images and the rate of using the second item, a need by the user for the second item;
responsive to identifying the need for the second item, generating a second user interface signal; and
sending, via the network, the second user interface signal to the device associated with the user, wherein the sending the second user interface signal causes the device to display the user interface with a message about the need for the second item and a second user interface element for use by the user to order the second item.

11. The method of claim 1, further comprising:
inferring, using the information about conversion of the collection of items by the training set of users, a conversion rate at which each user from the training set of users converts on each item of the collection of items;
training, using the training set of images and the conversion rate at which each user converts on each item of the collection of items, the usage prediction machine-learning model to generate a set of initial values for the set of parameters of the usage prediction machine-learning model; and
storing the set of initial values for the set of parameters of the usage prediction machine-learning model to a computer-readable medium of the online system.

12. The method of claim 1, further comprising:
collecting feedback data with information about whether the user ordered the item; and
re-training the usage prediction machine-learning model by updating, using the feedback data, the set of parameters of the usage prediction machine-learning model.

13. A computer program product comprising a non-transitory computer readable storage medium having instructions encoded thereon that, when executed by a processor, cause the processor to perform steps comprising:
receiving, via a network and from one or more devices associated with a user of an online system, one or more images of one or more physical spaces of the user that store a plurality of items;
accessing a usage prediction machine-learning model of the online system, wherein the usage prediction machine-learning model is trained by:
receiving, via the network and from a set of devices associated with a training set of users of the online system, a training set of images of a set of physical spaces of the training set of users that store a collection of items,
retrieving, from a database of the online system, conversion data including information about conversion of the collection of items by the training set of users,
generating a plurality of training examples using the training set of images and the conversion data, each of the plurality of training examples including one or more training images from the training set of images associated with a respective training user from the training set of users that are related to a respective item from the collection of items, and a portion of the conversion data related to conversion of the respective item by the respective training user,
for each of the plurality of training examples, applying the usage prediction machine-learning model to output a respective rate of a plurality of rates of using the respective item by the respective training user, and
updating, for each of the plurality of training examples and based on the plurality of rates, a set of parameters of the usage prediction machine-learning model;
applying the usage prediction machine-learning model to the one or more images to output a rate of using an item of the plurality of items by the user;
generating, based at least in part on the rate of using the item by the user, a first user interface signal; and
sending, via the network, the first user interface signal to a device of the one or more devices associated with the user, wherein the sending the first user interface signal causes the device to display a user interface with a user interface element, and wherein selection of the user interface element triggers an order of the item.

14. The computer program product of claim 13, wherein the instructions further cause the processor to perform steps comprising:
retrieving, from the database, transaction information in relation to conversions of the item by the user,
applying the usage prediction machine-learning model further to the transaction information to output the rate of using the item by the user;
identifying, based on the transaction information and the rate of using the item, that the user will be without the item before a next conversion session at the online system; and
responsive to identifying that the user will be without the item before the next conversion session, generating the first user interface signal.

15. The computer program product of claim 13, wherein the instructions further cause the processor to perform steps comprising:
receiving, via the network and from the device associated with the user, a signal including a query from the user in relation to a need for a second item of the plurality of items;
responsive to receiving the signal, generating a prompt for input into a language model, the prompt including the query and a request for the language model to extract, from the query, structured information about the query;
requesting the language model to generate, based on the prompt input into the language model, a response including the structured information about the query;
applying the usage prediction machine-learning model to the response from the language model and information about an existing inventory of the user in relation to the second item to output a rate of using the second item by the user;
identifying, based on the information about the existing inventory and the rate of using the second item, the need for the second item;
responsive to identifying the need for the second item, generating a second user interface signal; and
sending, via the network, the second user interface signal to the device associated with the user, wherein the sending the second user interface signal causes the device to display the user interface with a message about the need for the second item and a second user interface element for use by the user to order the second item.

16. The computer program product of claim 13, wherein the instructions further cause the processor to perform steps comprising:
receiving, from the device associated with the user and via the network, a location signal indicating that the user is in a vicinity of a second item of the plurality of items;
responsive to receiving the location signal, applying the usage prediction machine-learning model to the one or more images to output a rate of using the second item by the user;
responsive to receiving the location signal, retrieving, from the database, transaction information in relation to conversions of the second item by the user;
identifying, based on the transaction information and the rate of using the second item, that the user will be without the second item before a next conversion session at the online system;
responsive to identifying that the user will be without the second item before the next conversion session, generating a second user interface signal; and
sending, via the network, the second user interface signal to the device associated with the user, wherein the sending the second user interface signal causes the device to display the user interface with a message about a need by the user for the second item and a second user interface element for use by the user to order the second item.

17. The computer program product of claim 13, wherein the instructions further cause the processor to perform steps comprising:
receiving, from the device associated with the user and via the network, a request for a list of items related to a list of ingredients;
responsive to receiving the request, applying the usage prediction machine-learning model to the one or more images to output a rate of using each item from the list of items by the user;
identifying, based on the rate of using each item from the list of items and the one or more images, that the user is in possession of a sufficient quantity of one or more items from the list of items;
responsive to identifying that the user is in the possession of the sufficient quantity of the one or more items, generating a second user interface signal; and
sending, via the network, the second user interface signal to the device associated with the user, wherein the sending the second user interface signal causes the device to display the user interface with a message informing the user that the user is in the possession of the sufficient quantity of the one or more items.

18. The computer program product of claim 13, wherein the instructions further cause the processor to perform steps comprising:
retrieving, from the database, transaction information in relation to conversions of a set of items by the user at the online system;
identifying, based on the one or more images and the transaction information, a second item used by the user that was converted by the user outside of the online system;
responsive to identifying the second item, applying the usage prediction machine-learning model to the one or more images to output a rate of using the second item by the user;
identifying, based on the one or more images and the rate of using the second item, a need by the user for the second item;
responsive to identifying the need for the second item, generating a second user interface signal; and
sending, via the network, the second user interface signal to the device associated with the user, wherein the sending the second user interface signal causes the device to display the user interface with a message about the need for the second item and a second user interface element for use by the user to order the second item.

19. The computer program product of claim 13, wherein the instructions further cause the processor to perform steps comprising:
inferring, using the information about conversion of the collection of items by the training set of users, a conversion rate at which each user from the training set of users converts on each item of the collection of items;
training, using the training set of images and the conversion rate at which each user converts on each item of the collection of items, the usage prediction machine-learning model to generate a set of initial values for the set of parameters of the usage prediction machine-learning model;
storing the set of initial values for the set of parameters of the usage prediction machine-learning model to a computer-readable medium of the online system;
collecting feedback data with information about whether the user ordered the item; and
re-training the usage prediction machine-learning model by updating, using the feedback data, the set of parameters of the usage prediction machine-learning model.

20. A computer system comprising:
a processor; and
a non-transitory computer-readable storage medium having instructions that, when executed by the processor, cause the computer system to perform steps comprising:
receiving, via a network and from one or more devices associated with a user of an online system, one or more images of one or more physical spaces of the user that store a plurality of items;
accessing a usage prediction machine-learning model of the online system, wherein the usage prediction machine-learning model is trained by:
receiving, via the network and from a set of devices associated with a training set of users of the online system, a training set of images of a set of physical spaces of the training set of users that store a collection of items,
retrieving, from a database of the online system, conversion data including information about conversion of the collection of items by the training set of users,
generating a plurality of training examples using the training set of images and the conversion data, each of the plurality of training examples including one or more training images from the training set of images associated with a respective training user from the training set of users that are related to a respective item from the collection of items, and a portion of the conversion data related to conversion of the respective item by the respective training user,
for each of the plurality of training examples, applying the usage prediction machine-learning model to output a respective rate of a plurality of rates of using the respective item by the respective training user, and
updating, for each of the plurality of training examples and based on the plurality of rates, a set of parameters of the usage prediction machine-learning model;
applying the usage prediction machine-learning model to the one or more images to output a rate of using an item of the plurality of items by the user;
generating, based at least in part on the rate of using the item by the user, a first user interface signal; and
sending, via the network, the first user interface signal to a device of the one or more devices associated with the user, wherein the sending the first user interface signal causes the device to display a user interface with a user interface element, and wherein selection of the user interface element triggers an order of the item.
